(19) United States
(12) Patent Application Publication
(10) Pub. No.: US 2007/0297789 A1
(43) Pub. Date: Dec. 27, 2007

(54) Device and method for contaminant free lens changes of a digital camera

(76) Inventors: Guenter W. Brune, Bellevue, WA (US); John A. Milonas, Hobart, WA (US)

Correspondence Address: PRITZKAU PATENT GROUP, LLC, 993 GAPTER ROAD, BOULDER, CO, 80303, US

(21) Appl. No.: 11/472,962

(22) Filed: Jun. 22, 2006

(51) Int. Cl. G03B 19/00

(52) U.S. Cl. 396/429

(57) ABSTRACT

An exemplary embodiment providing one or more improvements includes a camera handling device and method in which airborne particles in a sealed container are trapped to prevent the particles from contaminating an image sensor of a digital camera while lenses are changed in the sealed container.

The present device and method relate generally to the field of photography and camera accessories, and more particularly, to an apparatus and method which reduce or eliminate the occurrence of contaminants depositing on the image sensor of a digital camera when lenses are changed.

### BACKGROUND

Digital cameras with interchangeable lenses such as digital single-lens reflex (DSLR) cameras have become very popular among amateurs and professional photographers alike. These digital cameras typically include a detachable lens that is attached to a camera body. The lens focuses an image onto an electronic image sensor in the camera body which electronically captures the image as an electronic picture. Reasons for the gain in popularity of these digital cameras include an increased image quality in comparison to previous digital cameras and the ability to replace and interchange lenses for changing the range of focal lengths of the camera, among other reasons.

One common problem found by DSLR camera users is that contaminants, such as dust particles, can enter the camera body and be deposited on the image sensor while the lens is detached from the camera body. The particles thereafter block a small portion of the image from reaching the image sensor, which causes spots on the electronic pictures. Since the image sensor is used for every picture taken, every electronic picture after the particle is deposited on the image sensor will have the spots in the same locations until the particles are removed.

Approaches to dealing with the image sensor contamination problem have centered on dealing with the particle or image spot after the particle is already on the image sensor, rather than preventing the particle from contaminating the image sensor in the first place. One such approach involves physically removing the particle from the sensor by using a blower to force the particle from the sensor with air. Other approaches use brushes or similar devices to physically contact and move the particle from the image sensor. Image sensors are very delicate and can therefore be easily damaged. Because of this, the image sensor must be cleaned following certain procedures and taking certain precautions. These procedures require special skills and knowledge that not every amateur or even professional photographer has mastered. Damage caused to the image sensor during cleaning may not be covered under warranty, especially if the cleaning procedures were not followed. Because of the risks involved in cleaning the image sensor, one manufacturer recommends sending its cameras to the manufacturer's service center when the image sensor needs to be cleaned.

In order to deal with dust entering the camera body, another manufacturer has a system which includes a dust-sheilding member in the camera body. The dust shielding member is positioned between the opening where the lens attaches to the camera body and the image sensor. The dust shielding member has a transparent portion which allows the image from the lens to reach the image sensor. The dust shielding member also has a piezoelectric element which vibrates the transparent portion in an effort to cause dust particles to fall off the transparent portion. This system adds weight and expense to the camera body and the system cannot be used with cameras from other manufacturers.

Other approaches to dealing with dust particles on the image sensor do not focus on removing the dust particles from the image sensor. These approaches are instead centered on electronically removing the spot from the electronic image. One such approach is to use a photo editing program such as Adobe Photoshop. In this approach, each electronic image is opened using the program and each of the spots caused by the dust particles is electronically removed. This approach is time-consuming since each electronic image must be individually corrected, and the quality of the results depends on the skills of the person using the program.

Another approach which electronically removes the spots from the electronic image is incorporated by a manufacturer into software that is included in their cameras. The software is designed to determine where spots or other anomalies occur on the image sensor. The software then corrects for these anomalies when each electronic image is taken. While the system may have its advantages, it is not universal and cannot be used with cameras by other manufacturers.

Both of the approaches which center on electronically removing the spot from the electronic image only compensate for dust and other particles sticking to the image sensor. This is also the case for the approaches described above in which the dust particles are removed from the image sensor by various means. None of these approaches are preventative; they are only reactions to the dust landing on the image sensor.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a device and method for changing a camera lens on a digital camera without introducing dust or other particles onto the image sensor are disclosed.

One embodiment, by way of example, is a method for preventing airborne contaminants from depositing on an image sensor of a digital single-lens reflex camera when changing lenses on the camera, where the camera includes a camera body that is selectively connectable to one or more camera lenses. The camera body is inserted with an attached lens into a container that is sealable from the ambient atmosphere and a replacement lens is also inserted into the container with the camera body and attached lens. The container is sealed from the atmosphere. Airborne contaminants from within the sealed container are trapped at a position in captured isolation away from the camera body, attached lens and replacement lens while the container is sealed. The attached lens is removed from the camera body and the replacement lens is installed on the camera body while the container is sealed. The container is then un-sealed to remove the camera body and attached replacement lens from the container.

In another embodiment, by way of example, an apparatus for preventing contaminants from depositing on an image sensor of a digital single-lens reflex camera when changing lenses on the camera is disclosed. The camera includes a camera body that is selectively connectable to one or more camera lenses. The apparatus includes a sealable container having an interior space that is large enough for the camera body along with an attached lens and a replacement lens, where the interior space is sealable from the atmosphere. A particle containment portion of the apparatus is used for trapping airborne particles from within the container at a position in captured isolation away from the camera body, attached lens and replacement lens while the container is sealed. A flexible manipulation portion of the container allows a user to remove the attached lens from the camera body and to install the replacement lens on the camera body while the container is sealed.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a partially cut-away plan view of a camera handling device along with a digital camera and lens.

FIG. 2 is partially cut-away plan view of the camera handling device shown in FIG. 1

FIG. 3 is a cut away elevation view of the camera handling device and digital camera shown in FIG. 1.

FIG. 4 is a partially cut-away perspective view of another embodiment of the camera handling device.

FIG. 5 is a flow diagram of a method for changing a lens.

FIG. 6 is a flow diagram of a method for attaching a lens to the camera body.

### DETAILED DESCRIPTION

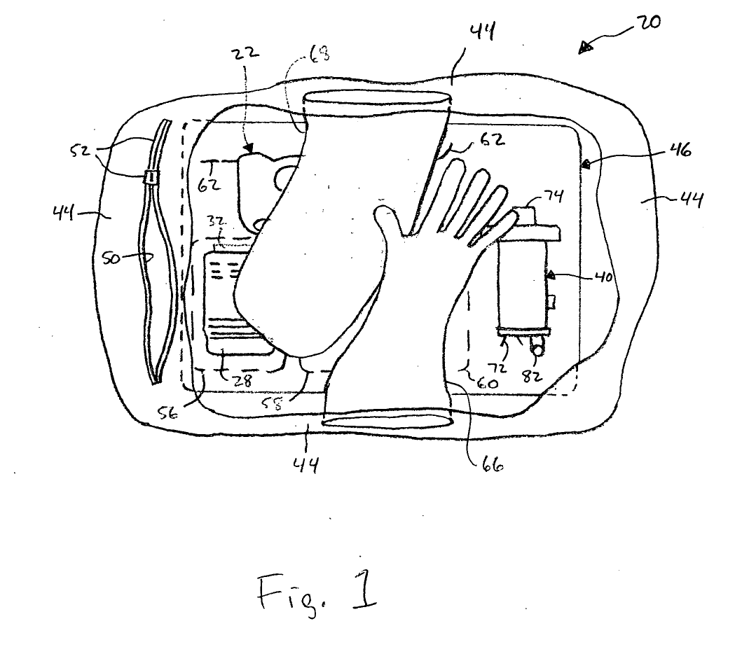

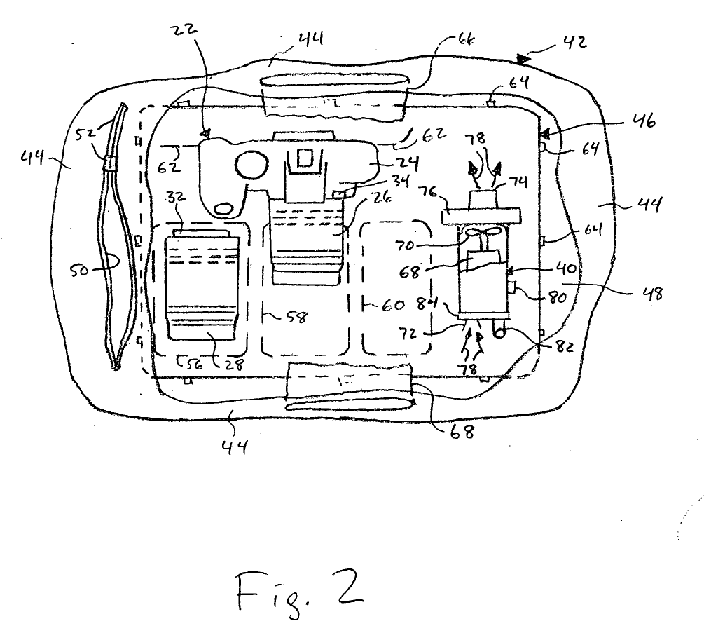

A camera handling device 20 according to the present description is shown in FIGS. 1 and 2 along with camera equipment including a digital camera 22 having a camera body 24 and a lens 26 that is attached to the camera body. Another lens, lens 28, is shown positioned adjacent to camera 22 and is interchangeable with lens 26. Lenses 26 and 28 are interchangeable by being individually attachable and detachable from camera body 24. Lenses 26 and 28 are attachable to camera body 24 using a body lens mount (not specifically shown) which engages a mounting portion 32 of lenses 26 and 28. Detaching the lens from the camera body typically involves pressing a lens mount button 34 and rotating the lens with respect to the camera body before pulling the lens away from the camera body. Moving the lens away from the camera body reveals a camera body opening (not shown) in the center of the lens mount. When the camera body opening is revealed, an image sensor (not shown) of camera body 24 is exposed to the surrounding atmosphere. If the surrounding atmosphere contains dust or other particles, then the dust particles can enter the camera body opening and deposit on the image sensor where the particles create spots on electronic images generated by the image sensor.

Camera handling device 20 creates a controlled atmosphere, which is substantially free of dust particles to allow lenses to be removed and attached with the camera body without introducing contaminants to the image sensor. Camera handling device 20 shown in FIGS. I and 2 includes a container 42 with walls 44 and a tray 46 that define an interior space 48. Camera handling device 20 controls the interior atmosphere in interior space 48 in a particle barrier mode by removing airborne particles in interior space 48 and preventing further particles from entering interior space 48. A filtration system 40 is used for trapping the airborne particles from within the interior space so that the particles cannot enter camera body opening and contaminate image sensor during lens changes. In addition, the interior space may be pressurized relative to the atmospheric pressure outside of the interior space to facilitate the filtering of contaminants, to provide easier manipulation of the camera equipment in the interior space or for other reasons.

A sealable opening 50 is defined by walls 44 to provide access to interior space 48 for passing camera body 24 and lenses 26 and 28 into and out of interior space 48. Opening 50 is sealable using any suitable sealing device, such as a zipper or fastener 52 which is manipulated for selectively opening sealable opening 50 to gain access to interior space 48, and for closing opening 50 to seal interior space 48. A substantially gas tight barrier is created between interior space 48 and the atmosphere surrounding the container 44 at the opening when fastener 52 seals opening 50.

Interior space 48 of container 42 is at least large enough to contain camera body 24 and lenses 26 and 28. In addition, interior space 48 has sufficient space to allow one of the lenses to be removed from the camera body and the other of the lenses to be installed on the camera body, all while interior space 48 remains in the particle barrier mode. Since camera bodies and lenses come in various sizes the container can be made in different sizes to accommodate the different sized equipment. For instance, long focal length lenses, such as those used by many wildlife photographers, are generally very large therefore in some instances the container would be large enough to acconmmodate the camera body and these large lenses.

Tray 46 may be formed from a rigid material such as plastic which provides a base for supporting camera body 24 and lenses 26 and 28. Tray 46 may include optional recesses or other features which are used for restraining camera body 24 and lenses 26 and 28 against unwanted movement. In the embodiment shown in FIGS. I and 2, recesses 56, 58 and 60 have a shape that is at least generally complementary to a shape of the lenses, while recess 62 has a shape that is at least generally complementary to a shape of camera body 24. The recesses are useful in preventing camera body 24 and lenses 26 and 28 from inadvertently contacting and damaging one another when they are in container 42.

Tray 46 can include other features or mechanisms for restraining the camera equipment in addition to, or in place of recesses. For example, tray 46 may include vertical ridges that rise above a flat surface of the tray and/or there may be a raised portion for securing camera body 24 while the lenses are being changed.

In the example shown in FIGS. 1 and 2, camera body 24 and lens 26 occupy recesses 58 and 62, and replacement lens 28 occupies recess 56 while recess 60 remains unoccupied. When lens 26 is removed from camera body 24, lens 26 is placed in unoccupied recess 60. Replacement lens 28 is then attached to camera body 24 after which the camera body and attached lens are placed in recesses 58 and 62 or 56 and 62. Typically replacement lens 28 will have a cap protecting the camera end of the lens. In these instances, the cap is removed from replacement lens 28 prior to installing lens 28 onto the camera body and the cap is placed on lens 26 after lens 26 is removed from the camera body. This way, the camera ends of the lenses 26 and 28 are only exposed to the environment in interior space 48.

In the example shown in FIGS. 1, 2 and 3, walls 44 of container 42 are made from a transparent flexible material such as plastic and the walls are removably attached to tray 46 using connectors 64. Connectors 64 allow the walls to be removed and replaced if they should become damaged, or for other reasons. While walls 44 are made from a transparent material, in some instances an opaque material may be used instead. In these instances, a transparent window (not shown in this example) forms a portion of the walls so that a user can see into interior space 48 of container 42 to manipulate the lens change.

Pockets 66 and 68 form a portion of walls 44, as shown in FIG. 1. Pockets 66 and 68 allow a user to grasp camera body 24 and lenses 26 and 28 while the camera equipment remains sealed in interior space 48. In the embodiment shown in FIG. 1, pocket 66 includes a glove shape while pocket 68 does not. The glove shape of pocket 66 allows a greater amount of freedom for the user's fingers than does pocket 68, that does not have the glove shape. Glove-shaped pocket 66 can be particularly useful in pressing lens mount button 34 to release the lens from the camera body, among other things. The pockets may define a large portion of the surface area of the container and in some instances may be at least half of the surface area of the container.

Camera handling device 20 may or may not include the optional pockets. Moreover, there may be one or more pockets, and the pockets may have similar or different shapes from one another and the pockets may be removable. In the embodiment shown in FIG. 1, pocket 66 is positioned toward a front portion of camera 22 while pocket 68 is positioned toward a rear portion of camera 22. This arrangement facilitates changing lenses since a user can grasp one of the lenses with one hand using pocket 66 while the user grasps camera body 24 with the other hand using pocket 68; however, other arrangements of pockets are readily apparent within the spirit of the invention. Pockets 66 and 68 are shown integrally formed with walls 44. In another embodiment, the pockets could be removably or permanently attached with holes in the walls. Camera handling device 20 does not need to include the pockets if walls 44 are sufficiently pliable to allow the user to remove and attach lenses 26 and 28 from camera body 24 by grasping the camera body and lenses using the walls. In these instances, the walls 44 constitute a flexible manipulation portion instead of, or in addition to one or more pockets.

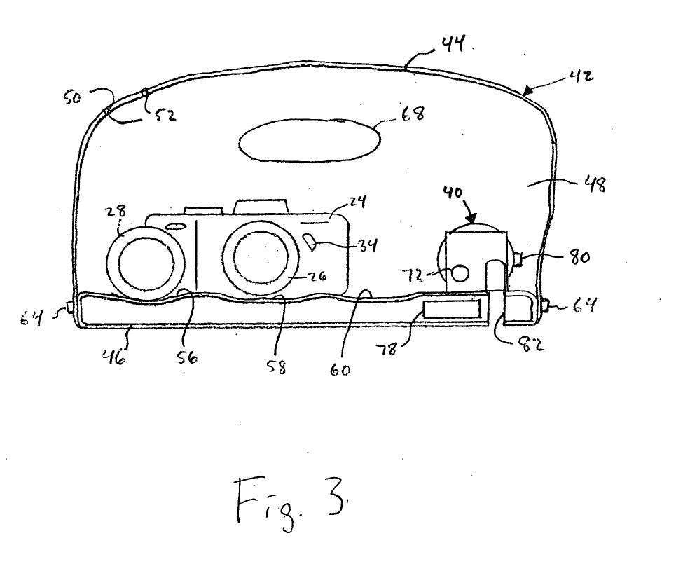

A partially cut away view of air filtration system 40 is shown in FIG. 2. Air filtration system 40 is shown mounted at an inside position on tray 46, although the air filtration system can also be mounted on the outside of the tray or in a hollow space of the tray if provided. The air filtration system includes a motor 68 that drives a fan 70 to move air in a direction represented by arrows 78 within interior space 48 from an inlet 72 to an outlet 74. Power from a battery 78 (FIG. 3) is fed through a switch 80 to motor 68 which causes fan 70 to rotate to move the air. The switch can be mounted in the interior space or on the outside of the container. Between inlet 72 and outlet 74 is a particle containment portion or filter 76 that traps particles contained in the air passing into air filtration system 40 through inlet 72 and prevents the particles from exiting air filtration system through outlet 74. Air filter 76 may be a HEPA filter or other type of air filter made from fabric, paper or other material having the ability to trap dust and other particles having a size capable of interfering with an image sensor.

By circulating the air in interior space 48 through the air filtration system, filter 76 traps airborne particles in the atmosphere in interior space 48. Filtering the airborne particles from the interior space reduces or eliminates the incidence of particles contaminating the image sensor while the lenses are removed from camera body 24. Air filtration system 40 has the capability of trapping a substantial majority of the particles that are airborne in interior space 48 in a few minutes. This allows lens changes to be made in a relatively short time in a relatively particle free environment. Any suitable expedient may be used for purposes of filtering or removing airborne particles.

In addition to filtering airborne particles from the atmosphere in interior space 48, air filtration system 40 is also used for pressurizing the interior space. Air filtration system 20 includes an exterior inlet port 82 that is controlled with inlet valve 84. Inlet valve 84 controls whether air from within interior space 48 is moved through inlet 72 into the air filtration system or if air from outside of container 42 is drawn into the interior space through inlet valve 84. Air drawn through inlet valve 84 also passes through filter 76 so that particles from outside of container 42 are not introduced into interior space 48.

In one instance, interior space 48 is pressurized or inflated by drawing air through inlet valve 84 to increase the volume of the interior space so that walls 44 do not contact or otherwise interfere with the manipulation of the camera body and lenses. At least partially inflating the interior space facilitates the use of the pockets or walls to manipulate the camera body and lenses by helping to maintain a space between the walls and the camera equipment. In another instance, air or another gas, such as CO₂ is introduced into the interior space using a cartridge (not shown). Container 42 can be depressurized or deflated by opening sealable opening 50 or the air can be removed using the inlet valve or another device in a powered deflation mode.

In another embodiment a vacuum hose (not shown) may be connected to inlet 72. The vacuum hose allows the user to vacuum dust or other particles from the camera body and lenses by moving an end of the hose into close proximity to the camera equipment. The vacuum hose in conjunction with the air filtration system can be used to dislodge and trap particles to prevent them from becoming airborne in the container.

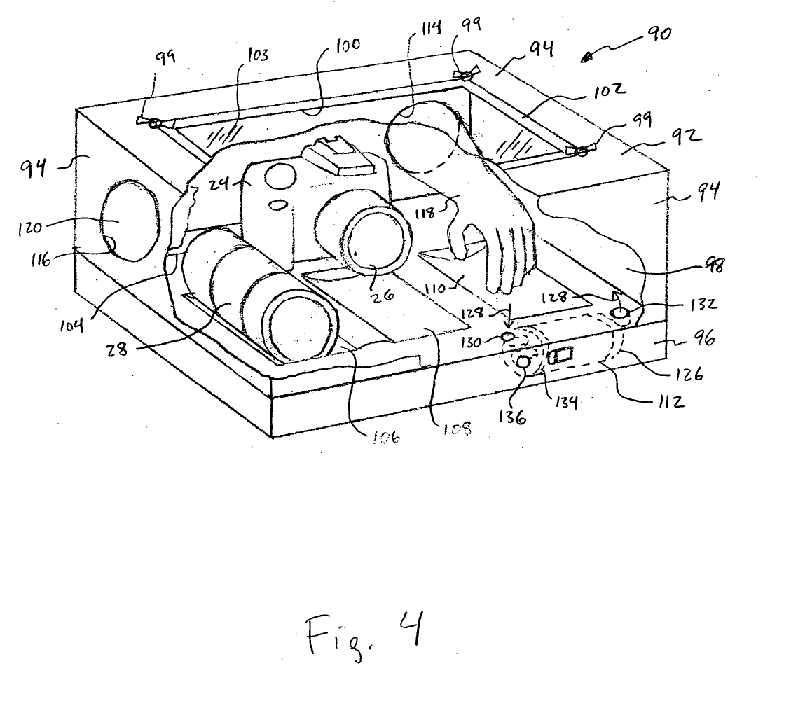

Camera handling device 90, shown in FIG. 4, is another embodiment according to the present disclosure. Camera handling device 90 includes a container 92 having walls 94 and a tray 96 which define an interior space 98. In this example, walls 94 of container 92 are made from a rigid material, such as plastic. The rigid container walls could be fixed in a rigid shape as shown, or may be foldable into a more easily transportable arrangement.

A sealable opening 100 is defined by walls 94 to provide access to interior space 98. Opening 100 allows camera body 24 and lenses 26 and 28 to be passed into and out of the interior space. Opening 100 is sealable using a sealing device such as lid 102 which is removeably attachable to walls 94. In the example shown, lid 102 is attached using connectors 99. Attaching lid 102 to walls 94 with connectors 99 seals interior space 98. Detaching lid 102 from walls 94 exposes opening 100 for access to the interior space. A substantially gas tight barrier is created between interior space 98 and the atmosphere surrounding container 92 when lid 102 is attached to walls 94, such that communicating with the external environment requires air flow through the filtration system.

Tray 96 includes recess 104 for camera body 24 and recesses 106, 108 and 110 for lenses 26 and 28. Tray 96 is constructed of a material, such as plastic, which will support the camera body and lenses as well as providing a mounting support for an air filtration system 112. Tray 96 can be formed of the same or different material as walls 94 and can be formed separately or as a single unit with the walls.

Pockets 118 and 120 (shown partially cut-away) are attached to walls 94 and the walls define holes 114 and 116 which pockets 118 and 120 extend across. Pockets 118 and 120 are sized to allow the user to at least place a hand in each of the pockets to reach and grasp the camera body and lenses in interior space 98. Pockets 118 and 120 are relatively flexible which allows the user to grasp the camera body and lenses and to manipulate a lens change from the exterior of container 92 while the container remains sealed.

In the example shown in FIG. 4, walls 92 are made of an opaque material. An observation window 103 is included in lid 102 in order for the user to see into interior space 98. Window 103 is substantially transparent and is positioned to allow the user to view the interior space while manipulating the camera body and lenses using pockets 118 and 120.

Air filtration system 112 is mounted to tray 96. Air filtration system 112 includes a motor which drives a fan to move air through the system in the direction shown by arrows 128. Air in the interior space 98 enters the system 112 through an inlet 130 and exits the system through outlet 132. Airborne particles enter the inlet with the air and are trapped by filter 126.

An inlet valve 134 controls whether air flows through inlet 130 from the interior space or whether air flows through an inlet 136 from outside of the container 92 to the filter and the outlet. Air flowing into the system from outside of the container is used to pressurize interior space 98.

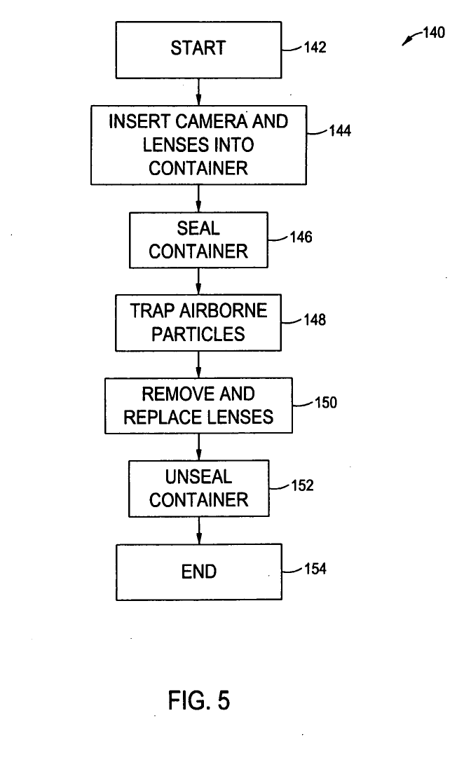

A method 140 involving removing airborne particles from a space to facilitate changing a camera lens without contaminating the image sensor is shown in FIG. 5. Method 140 starts at 142 after which the method proceeds to 144 where a camera body and attached lens along with another lens are inserted into the interior space of the container. After the camera body and lenses are inserted into the interior space, the interior space is sealed at 146. Following 146 the method moves to 148 where airborne particles inside of the container are trapped away from the camera body and lenses. After the air is filtered at 148 the method continues at 150 where the lens is detached from the camera body and replaced by the other lens while the container remains sealed. During the lens replacement, the image sensor is exposed to the air in the interior space from which the airborne particles were removed. The method continues at 152 where the container is unsealed to allow the camera to be removed from the interior space. The method then ends at 154.

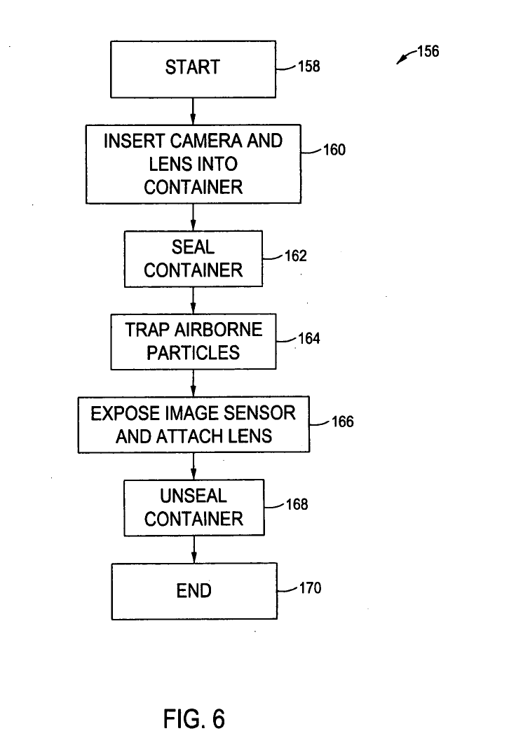

Another method 156 involving removing airborne particles from a space to facilitate attaching a lens to a camera body without contaminating the image sensor is shown in FIG. 6. Method 156 starts at 158 from which the method proceeds to 160. At 160, the camera body and a lens are inserted into the interior space of the container. In this instance, a removable cap covers the camera body opening to prevent dust or other contaminants from entering the opening and contaminating the image sensor while the camera body is in an uncontrolled environment. Another cap typically covers the camera end of the lens to prevent contamination of the lens.

After the camera body and lens are inserted into the interior space, the interior space is sealed at 162. Following 162 the method moves to 164 where airborne particles inside of the container are trapped away from the camera body and lenses. After the air is filtered at 164 the method continues at 166 where the caps are detached from the camera body and the lens, and the lens is attached to the camera body while the container remains sealed. During the procedure, the image sensor is exposed to the air in the interior space from which the airborne particles were removed or otherwise filtered or trapped. The method continues at 168 where the container is unsealed to allow the camera to be removed from the interior space. The method then ends at 170.

The camera handling device may be incorporated into a photographer's gadget bag. In this instance the tray may be used for securing the camera body and lenses during transport and other times. As an example, hook and loop fasteners such as Velcro tape may be provided to secure the body and/or lens to the tray.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for preventing airborne contaminants from depositing on an image sensor of a digital single-lens reflex camera when changing lenses on the camera, the camera having a camera body that is selectively connectable to one or more camera lenses, the method comprising:
inserting the camera body and at least one lens into a container that is sealable from the ambient atmosphere;
sealing the container from the atmosphere;
trapping the airborne contaminants from within the sealed container at a position in captured isolation away from the camera body and lens while the container is sealed;
exposing the image sensor to the sealed interior of the container while the container is sealed;
installing the lens on the camera body while the container is sealed; and
un-sealing the container to remove the camera body and attached lens.

2. A method as defined in claim 1 wherein two lenses are inserted with the camera body and one of the lenses is attached to the camera body when inserted, and exposing the image sensor includes removing the attached lens from the camera body.

3. A method as defined in claim 1 wherein one lens is inserted with the camera body and the image sensor is exposed by removing a cap from the camera body.

4. A method as defined in claim 1 wherein the container contains a gas and the contaminants are trapped by circulating at least a portion of the gas in the container through a filter.

5. A method as defined in claim 1 wherein the contaminants are trapped at a position within an outside perimeter of the container.

6. A method as defined in claim 1 wherein the attached lens is removed by manipulating the attached lens through a flexible material that forms at least a portion of the container.

7. A method as defined in claim 6 wherein the flexible material includes at least one pocket.

8. A method as defined in claim 1 wherein trapping the contaminants includes trapping dust particles.

9. A method as defined in claim 1 further comprising adding gas to the container after sealing the container.

10. A method as defined in claim 9 wherein adding the gas to the container causes the container to inflate.

11. A method as defined in claim 9 wherein adding the gas to the container includes adding air to the container.

12. A method as defined in claim 1 further comprising removing gas from the container after sealing the container.

13. A method as defined in claim 1 wherein the camera body with the attached lens is placed on a tray when inserted into the container.

14. A method as defined in claim 1 wherein the replacement lens is placed on a tray when inserted into the container.

15. A method as defined in claim 1 wherein the container is sealed using a fastener.

16. An apparatus for preventing contaminants from depositing on an image sensor of a digital single-lens reflex camera when changing lenses on the camera, the camera having a camera body that is selectively connectable to one or more camera lenses, the apparatus comprising:
a sealable container that includes an interior space large enough for the camera body with an attached lens in addition to a replacement lens, the interior space being sealable from the atmosphere;
a particle containment portion for trapping airborne particles from within the container at a position in captured isolation away from the camera body, attached lens and replacement lens while the container is sealed; and
at least one flexible manipulation portion of the container for allowing a user to remove the attached lens from the camera body and to install the replacement lens on the camera body while the container is sealed.

17. An apparatus as defined in claim 16 wherein the container contains a gas and the particle containment portion further comprises:
a fan for circulating the gas in the container; and
a filter for trapping the airborne particles.

18. An apparatus as defined in claim 17 wherein the gas is air.

19. An apparatus as defined in claim 17 wherein the filter is a HEPA filter.

20. An apparatus as defined in claim 17 wherein the filter is positioned in the interior space of the container.

21. An apparatus as defined in claim 16 wherein the flexible manipulation portion is at least half of a surface area of the sealable container.

22. An apparatus as defined in claim 16 wherein the flexible manipulation portion has a glove shape.

23. An apparatus as defined in claim 16 wherein the flexible manipulation portion is removable from the sealable container.

24. An apparatus as defined in claim 16 further comprising:
a gas valve extending through a wall of the container for controllably passing a gas between the exterior and the interior of the container.

25. An apparatus as defined in claim 16 wherein the container is made from a collapsible bag.

26. An apparatus as defined in claim 16 further comprising:
a tray which defines a portion of the container, the tray being configured for restraining at least one of the camera body or replacement lens against movement.

27. An apparatus as defined in claim 26 wherein the tray includes at least one recess for restraining the camera body or replacement lens against movement.
